(19) United States
(12) Patent Application Publication
(10) Pub. No.: US 2015/0348498 A1
(43) Pub. Date: Dec. 3, 2015

(54) DIGITAL BADGE AND SIGNAGE SYSTEM AND METHOD

(71) Applicant: IDENTITY SYSTEMS, INC., Columbus, OH (US)

(72) Inventors: Patrick Terry ANDERSON, Galena, OH (US); Judith Anne ANDERSON, Galena, OH (US); Christopher Michael JOHNSON, Powell, OH (US); Ronald Anthony KUPPINGER, Columbus, OH (US)

(21) Appl. No.: 14/724,255

(22) Filed: May 28, 2015

Related U.S. Application Data
(60) Provisional application No. 62/005,309, filed on May 30, 2014.

(51) Int. Cl. G09G 5/00; G06F 3/147; G06F 1/16

(52) U.S. Cl. CPC G09G 5/006; G09G 5/005; G06F 1/163; G06F 3/147; G09G 2380/04; G09G 2370/02; G09G 2370/04; G09G 2360/10; G09G 2320/10

(57) ABSTRACT

Systems, methods, apparatuses, and computer program products for digital badges, signs, or any other type of display are provided. One apparatus is directed to display device that may include a microprocessor, a memory, and a display. The microprocessor and the memory are configured to control the display device to receive content from a network device, receive at least one rule used by the microprocessor to determine when the content is displayed, and display the received content on the display according to the at least one rule.

### CROSS-REFERENCE TO RELATED APPLICATIONS:

This application claims priority from provisional application No. 62/005,309 filed on May 30, 2014. The entire contents of this earlier filed application are hereby incorporated by reference in its entirety.

### BACKGROUND

1. Field

Certain embodiments generally relate to electronic or digital signage, badges, displays or other types of systems or signs used to show information about something.

2. Description of the Related Art

Companies and businesses of all kinds, such as retailers, hotels, restaurants, use badges to identify their employees. Typical badges now in use are plastic or metal panels that are either engraved or fully configured at the time of manufacture, or can be customized in a limited way by the client after manufacture (e.g., by changing the employee's name via a paper insert; or attaching a promotional or seasonal tag add-on).

Although these types of badges work fine, they have characteristics that may not be desirable for certain clients and applications. For instance, for badges that depict an employee's name, usually one badge will be required per employee. This means every time an employee joins the team, or an existing team member loses his badge, a badge needs to be ordered, and the employee will work without a badge while a new badge is shipped. This also means that when an employee leaves the team, the client is left with a badge that may never be reused. This is especially concerning for companies that have a high rate of employee turnover or seasonal employees.

In addition, these traditional types of badges are permanently branded such that businesses incorporate company logo, color scheme, slogan and other brand elements into name badges. When the company changes its branding, the badges all must be replaced at a significant cost. This is especially concerning for companies that have a history of regular brand updates.

### SUMMARY

One embodiment is directed to a display device that may include a microprocessor, a memory, and a display. The microprocessor and the memory are configured to control the display device to receive content from a network device, receive at least one rule used by the microprocessor to determine when the content is displayed, and display the received content on the display according to the at least one rule. In certain embodiments, rules and/or events are defined for when and where the received content is displayed on the display of the display device.

In an embodiment, the display device may be an identification badge. According to one embodiment, the display device may be configured to be associated with an individual or employee, and to then automatically display at least the name of the individual or employee based on the association. The display device may have a unique device identifier.

In some embodiments, the display device may also include mounting hardware configured to mount the display device on clothing of a person. The display device may include a power source.

According to certain embodiments, the display device may further include a loss prevention device configured to deactivate the display device when the display device is removed from a predefined premises.

In one embodiment, the display device may also include at least one sensor configured to create data and/or observations and to transmit the data and/or observations to the network device in near real-time or to store the data to transmit to the network device at a pre-determined time.

Another embodiment is directed to a method which may include receiving, at a microprocessor of a display device, content from a network device, receiving at least one rule used by the microprocessor to determine when and how the content is displayed on the display device, and displaying the received content on a display of the display device according to the at least one rule. In one embodiment, the method may include defining rules and/or events for when and where the received content is displayed on the display of the display device.

In an embodiment, the displaying may further include displaying the received content on an identification badge. According to some embodiments, the display device may include mounting hardware configured to mount the display device on clothing of a person.

In some embodiments, the method may also include providing, by a power source, power to the display device. According to one embodiment, the method may also include deactivating, by a loss prevention device, the display device when the display device is removed from a predefined premises.

According to an embodiment, the method further includes creating, by at least one sensor of the display device, data and/or observations, and transmitting the data and/or observations to the network device in near real-time or storing the data to transmit to the network device at a pre-determined time.

In an embodiment, the display device has a unique device identifier. According to some embodiments, the method may also include associating the display device with an individual, and displaying at least a name of the individual on the display device.

Another embodiment is directed to a computer program, embodied on a non-transitory computer readable medium. The computer program may be configured to control a processor to perform a process, which may include receiving, at a microprocessor of a display device, content from a network device, receiving at least one rule used by the microprocessor to determine when and how the content is displayed on the display device, and displaying the received content on a display of the display device according to the at least one rule.

### BRIEF DESCRIPTION OF THE DRAWINGS:

For proper understanding of the invention, reference should be made to the accompanying drawings, wherein:

FIG. 1 illustrates a block diagram of a system according to one embodiment;

FIG. 2 illustrates a block diagram of a system according to another embodiment;

FIG. 3 illustrates a flow diagram of a method according to one embodiment;

FIG. 4 illustrates a flow diagram of a method according to another embodiment;

FIGS. 5a, 5b, and 5c illustrate a flow diagram of a method according to another embodiment;

FIG. 6 illustrates a flow diagram of a method according to another embodiment;

FIG. 7 illustrates a flow diagram of a method according to another embodiment;

FIG. 8 illustrates a flow diagram of a method according to another embodiment;

FIG. 9 illustrates a flow diagram of a method according to another embodiment;

FIG. 10 illustrates a flow diagram of a method according to another embodiment;

FIG. 11 illustrates a flow diagram of a method according to another embodiment;

FIG. 12 illustrates a flow diagram of a method according to another embodiment;

FIG. 13 illustrates a flow diagram of a method according to another embodiment;

FIG. 14 illustrates a flow diagram of a method according to another embodiment;

FIG. 15 illustrates a flow diagram of a method according to another embodiment;

FIG. 16 illustrates a flow diagram of a method according to another embodiment;

FIG. 17 illustrates a flow diagram of a method according to another embodiment;

FIG. 18 illustrates a flow diagram of a method according to another embodiment;

FIG. 19 illustrates a flow diagram of a method according to another embodiment;

FIG. 20 illustrates a flow diagram of a method according to another embodiment;

FIG. 21 illustrates a flow diagram of a method according to another embodiment;

FIG. 22 illustrates a flow diagram of a method according to another embodiment;

FIG. 23a illustrates an example display of a device, according to one embodiment; and

FIG. 23b illustrates another example display of a device, according to another embodiment.

### DETAILED DESCRIPTION:

It will be readily understood that the components of the invention, as generally described and illustrated in the figures herein, may be arranged and designed in a wide variety of different configurations. Thus, the following detailed description of the embodiments of systems, methods, apparatuses, and computer program products for digital badges, signs, or any other display, as represented in the attached figures, is not intended to limit the scope of the invention, but is merely representative of selected embodiments of the invention.

If desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

### Product Model

Embodiments of the invention provide a digital approach to name badges that can introduce valuable new product characteristics. For example, some characteristics of digital badges, according to embodiments of the invention, may include shared badges, dynamic content, real-time content, and/or two-way communications.
Shared badges—every name badge can be used by any employee. The number of badges required by a client is the number of employees clocked-in at any one time; not the total number of employees. A new team member can have a working badge right away; and additional badges can be ordered or obtained without concern for what a new team member's name is. Digital badges do not need to be replaced due to employee turnover.
Dynamic content—the name badge can present changing information, not just the employee's name. In addition to employee name, title and other basic information, the client can choose to use part of the badge real estate to present other information. Branding, seasonal greetings, daily promotions . . . the extra information presented on a badge is only limited by badge real estate. Content could be updated per-day, when each employee clocks in, or at other times (depending on how often a badge can receive new instructions—see next bullet).
Real-time content—moving beyond the idea of daily updated content, badges with a wireless update capability could present new information throughout the day. Content that differs with the time of day (e.g. meal deals at restaurants) could be updated as needed. Badges could determine their location, and display information specific to that department. Badges could change content based on specific events—e.g. remove a product promotion when that particular product sells out. Wireless updates make any number of “live” data applications possible.
Two-way communication—moving beyond being a simple display, badges could provide valuable information to clients. Employee current location, movement patterns, store temperature and other data could be collected by the badge, and transmitted to store systems either in real-time (wireless), or at the end of the employee's shift. Employees could also trigger communication—e.g. push a button to trigger a request for manager assistance, to send an alert regarding a security problem, or to allow 1- or 2-way voice communication via the badge.

These concepts can be extended to other digital information displays/signs, e.g., large billboard-style signs on store walls, smaller screens used to advertise products in specific store departments, very small screens used to display specific offers (product information/pricing) on grocery shelves, retail clothes shelves/racks, mounted on shopping carts, on tabletops and POS terminals. Clients could replace printed or manually-reconfigured displays with various formats of electronic signs with the dynamic/real-time content, sensor/two-way communication and other capabilities described above.

The digital product, according to embodiments of the invention, may drive significant changes in the ID badge & signage markets:
1. Technology platform: Currently, badges are seen as little more than name tags and possibly some branding. In a digital approach, the badges can become a mobile technology platform that enables all manner of communications: brand to consumer, manager to employee, employee to manager, sensor to store systems, and so on. In an embodiment, the badge system may be thought of as a network of small computers, communicating wirelessly while moving around the store or business. A number of product capabilities may be added, depending on the specific technology stack and price point: panic buttons, wireless voice communication, location sensors, visual paging, for instance. As one example, how valuable would it be to a restaurant to understand how often its wait staff passes through the kitchen door at certain times of day?
2. Advertising platform: Retailers will be able to define what parts of a badge/sign are used for what content/purpose. One content type can be ads or sponsored content from consumer brands or other sponsors. For example, a retailer could define part of the badge real estate as ad content, and allow a company to push small ad graphics to this area on every employee's badge for some period of time. This could be via a direct relationship between retailer & vendor, or via an ad auction & distribution mechanism that serves multiple participants.
3. Advertising economics: Allowing advertising on badges & signs creates value that can be captured. Retailers could negotiate direct benefits from advertisers: e.g., better pricing or other commercial terms, or a direct fee. The network owner could negotiate fees from advertisers, and share these with retailers in various ways: e.g. direct payments, or in return for a reduced price badge/signage hardware, software & services.

### Operation

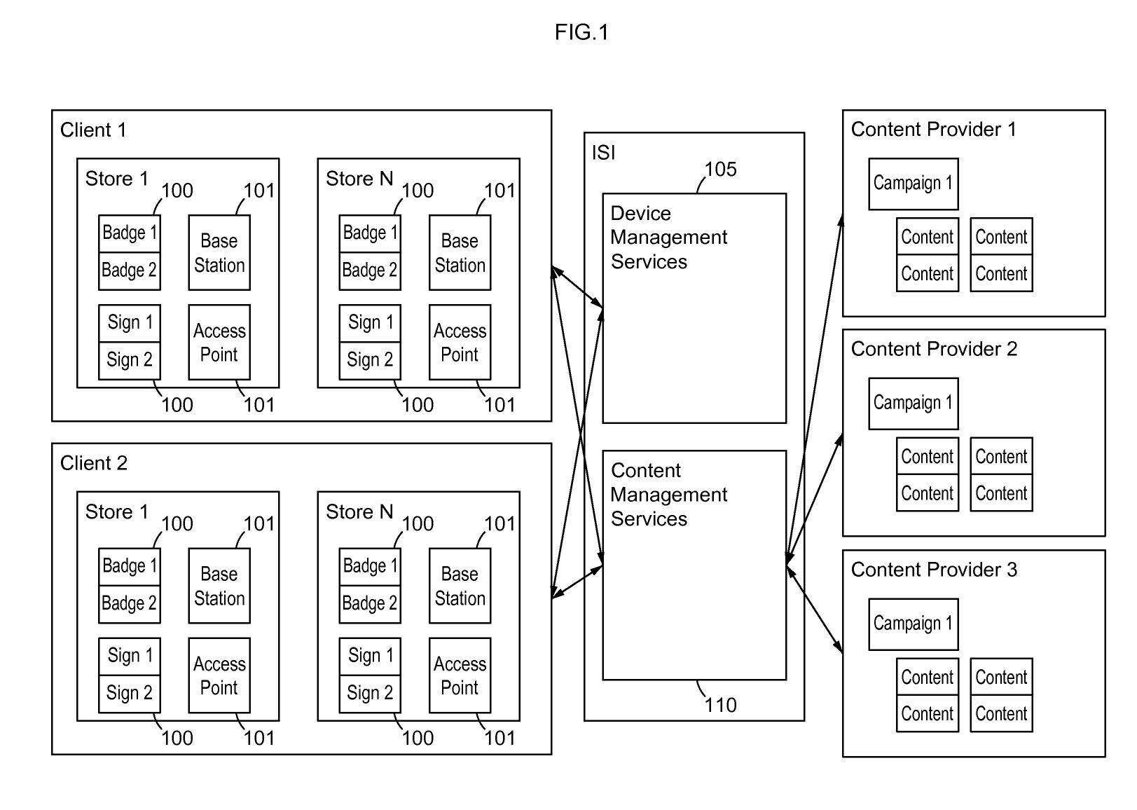

FIG. 1 illustrates a block diagram of a system in terms of modular capabilities in hardware, software & services layers, according to one embodiment. In an embodiment, the system of FIG. 1 may include a combination of distinct elements:
(a) Display devices 100, e.g. individual identity badges and signs;
(b) Support devices 101, e.g. base stations and wireless access points;
(c) Device management services 105 (software and network);
(d) Content management services 110 (software and network);
(e) Field support services (in-person install & maintenance).

### Display Devices

According to one embodiment, the system may support many distinct device configurations. At any given time, several device types may be provided, to appeal to individual clients' preferences regarding size, format, color, cost, and so on. It is noted that embodiments of the invention are able to support changes in available technologies and price points and changes in choice of displays, batteries, and other components.

Each individual device may be uniquely identifiable, and can be characterized by its unique configuration. Device ID may be used by the device management and content management layers to determine how the device should be configured & operated, due either to its identity (brand/location), or its capabilities (screen size, resolution, color depth, sensor enabled, etc.).

Display Device Subsystems

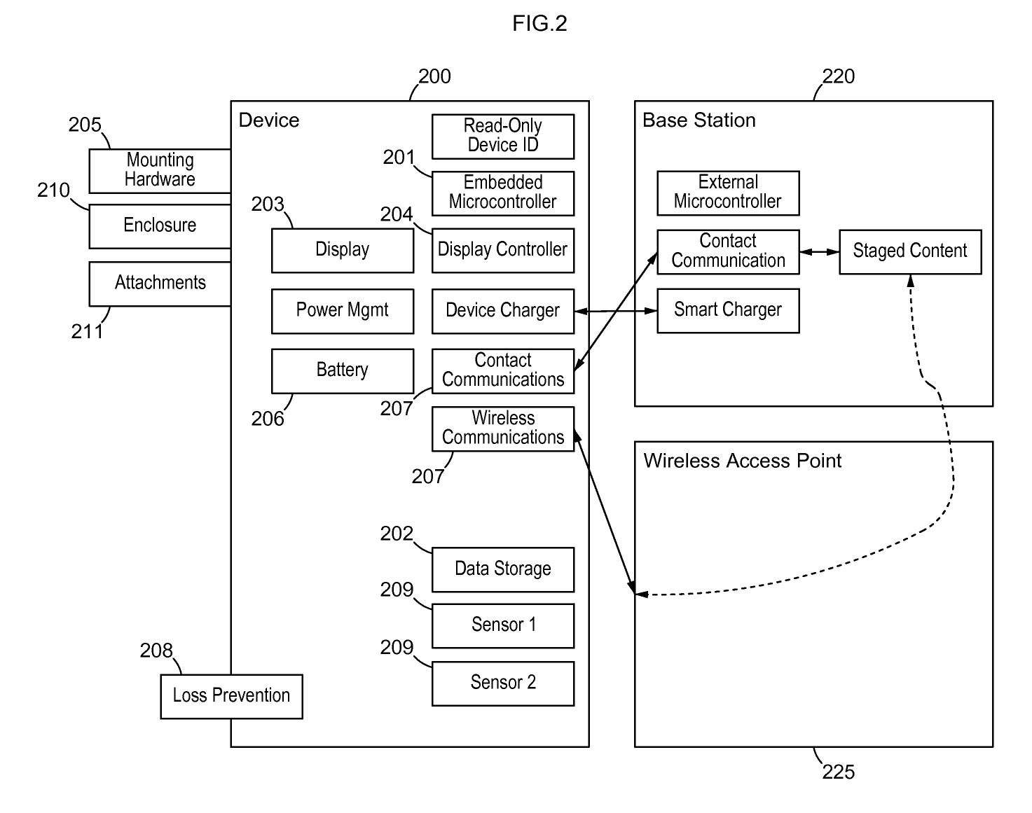

As illustrated in FIG. 2, according to certain embodiments, display devices 200 will be constructed using a combination of functional subsystems:
(a) Display device 200 may include mounting 205. For example, display device 200 (e.g., badges) may be attached to people/clothing using pins, any peel and stick adhesive, glued or molded pin, jewelers pin, wire crimp or straight pin, safety pin, plastic enclosed pin, combination pin/clip, pin retainer, welded pins, welded glue pin, molded enclosure with pin or clip, military clutch pin(s), clothespin plastic clips, clip adapters, pocket clips, glued or peel and stick adhesive magnets, hook and loop material (e.g. Velcro), adhesives, buttons, belt loops, lanyards, strap clip with hole, bulldog clips, alligator clips, etc. Signs will use various standards, bases, adhesives, metal and plastic mounting brackets, metal and plastic stands, magnets, etc.
(b) Display device 200 may include microcontroller/microprocessor 201. Devices that include logic for how and when to update content, e.g. display pre-loaded content based on clock time, or fetch and display content when available from a network, will require a microcontroller. Examples include embedded (e.g. Cortex M3) or attached (e.g. Electric Imp card). Display device 200 may also include storage 202, such as flash memory and/or ROM. Devices that don't update except when returned to a base station may not require a microcontroller; logic for this type of update can be via a controller in the base station instead of in each device.
(c) Display device 200 may have a Device ID. Examples include visual (serial number, bar code, QR code) and/or electronic (NFC chip UID, embedded network device MAC address, microcontroller embedded ID, data stored in device ROM) etc.
(d) Display device 200 may include a display 203. Examples include paper-white LCD, chip-on-glass LCD, Organic LED (OLED), or TFT active matrix. Note that devices may not need an actual display if only sensor/communication abilities are required.
(e) Display device 200 may also include a display controller 204. Depending on the display type and microcontroller capability, the display controller may be integrated in the display itself (e.g. HX8312 chip on TFT displays), may be a separate module (e.g. SSD1963 chip on controller board), or the microcontroller may implement the display controller function directly.
(f) Display device 200 may include a power source 206. Examples include rechargeable and non-rechargeable batteries and battery packs (typically Lithium Ion), plus power management capabilities such as contact, pluggable or inductive charger interface, over- and under-charge protection, reverse polarity protection, etc. Note that devices with passive/persistent displays (like paper-white LCD) may only require power while the display is being actively updated at a base station.
(g) Display device 200 may also include communication interface(s) 207. For example, hardware & related software stack used to receive content, data/rules (e.g. times to display different content), device configuration etc. from device & content management layers. Examples include Wifi, Bluetooth, Bluetooth Low Energy (BLE), Ethernet, USB, contact serial, discrete SD/micro-SD card, etc.
(h) Display device 200 may include a loss prevention component or device 208. Devices may need to be protected from intentional or accidental removal from client premises. Examples include the various commercial anti-theft technologies (magnetic, acousto-magnetic, microwave etc.). May include an option for active prevention—deactivation of the device when anti-theft device is triggered.
(i) Display device 200 may include sensors 209. For example, devices may include a variety of sensors that (a) create data/observations (temperature, humidity, location, device ID etc.); (b) transmit data to the network in near real-time; and/or (c) store data to transmit to the network at a pre-determined time or when a wired or wireless communication channel becomes available.
(j) Display device 200 may include a physical enclosure 210. How the device is packaged in one or more modules. All subsystems could be packaged into a single enclosure; or >1 enclosures could be integrated by mechanical+electrical connectors. Different types of enclosure can be used to address different requirements re: mechanical shock, humidity/water immersion, temperature, electrostatic and other conditions that are likely to differ per client/industries served.
(k) Display device 200 may include non-digital attachments 211. The digital device can be combined with non-digital assets, such as paper or plastic displays placed on, around, in front of or behind the digital display or other parts of the device/enclosure.

### Support Devices

Depending on the device configuration(s) chosen by a client, different support devices may be required on premise. As illustrated in FIG. 2, Such devices may include:
(a) Base stations 220: The base station is a physical point of integration for mobile devices (badges & maybe smaller signs). For example, employees may take badges from a rack that comprises the base station when starting a shift, and return badges after their shift is done.
   The base station 220 may provide electrical power via plugs, contacts or wireless charging. Depending on the specific device configuration, power management features (over-charge protection, battery conditioning etc.) may be implemented in either the base station (for cost savings) or in the device or both.
   The base station 220 can identify which individual devices are attached or in the effective range of the base station; and trigger actions that relate to the device ID (e.g. request updated device content from network if not previously staged to the base station, begin download of new content for device).
   For devices that lack a wireless update capability, the base station 220 provides updates via some physical connection, e.g. Ethernet, serial over USB, serial over device contacts, SD/micro-SD card writer etc.
(b) Wireless Access Points 225: Depending on the wireless technology used by the devices, these could be Wifi access points, Bluetooth (or BLE) access points, hybrid Wifi/Bluetooth (or BLE) access points, or something else.
   These can be new access points deployed specifically for the system; or may be a user's existing infrastructure if suitable. In small stores, the wireless access point could be a module in the single base station. In larger stores, there may be one base station+multiple wireless access points for coverage.
   Display devices will be configured to indicate which specific access point(s) can be used for secure communication. Example: specific access point SSID's, WPA passphrases, and/or subnet masks). This would prevent devices from attempting to communicate with other networks, e.g. neighboring stores.
(c) Remote Sensors:
   In cases where the device can act as a beacon (reporting its presence or location via e.g. wireless or NFC signal), additional networked devices can be placed throughout the client premises to receive the beacon signal. If the wireless protocol used is short-range (e.g. Bluetooth Low Energy), the Wireless Access Points may serve this purpose. However if the wireless protocol used is long-range (e.g. Wifi), remote sensors that respond to short-range signals (e.g. NFC or BLE) could also be deployed.

### Device Management

The device management layer is responsible for tracking and configuring devices throughout their lifecycle. Note the definition of “device” here includes badges, signs and other on-premise equipment like base stations and access points.
(a) Device provisioning: When a device is originally assembled, before being activated for a specific client or location, record data about the device, and give the device its temporary (until-assigned) configuration.
   Define and record unique device ID, and imprint device with ID.
   Update device firmware, and store initial device software & other data.
   Record device configuration, including both fixed and changeable characteristics.
(b) Device activation: When a device is assigned to a client, configure the device and make it usable.
   Accept device activation requests—clients and/or client services team may request number/type of devices, required configuration, delivery date & location etc. Provide ongoing status updates to requesters.
      Commerce process—integrate with order management/other systems to accept purchase orders, issue PO acknowledgements/advance ship notices etc. as required by each client.
   Assign the device to the client. Depending on client requirements, the brand, location etc. may be defined at the same time (e.g. in a ship to store scenario), or may be defined later (e.g. in a ship to distribution center scenario in which the client determines later which device is sent where).
   Update device configuration per specific activation request.
      Hard configuration—create work order for a team member to assemble device (batteries etc.)
      Soft configuration—automated process to update software and data configuration.
      Verify device configuration and record in device directory.
   Update client-specific security/network access. Send device identifiers to public networks (if any) device will communicate via. Test network connectivity with client and indicate pass/fail.
   Device fulfillment—issue work orders for pick/pack/ship of devices.
      Commerce process—integrate with other systems to issue ship notices/etc.
(c) Directory services: Define objects and roles/permissions for device management framework.
   Models directory—master data regarding available device configurations, aka templates.
   Device directory—master data regarding individual devices, and their configuration/status.
   Client directory—master data regarding clients/brands, stores, their requirements/options.
   Content provider directory—master data regarding advertisers and other content providers.
   Other types of master data.
(d) Users & permissions services: Defines groups of users, individual users, and their permissions in the system.
   Closely related to client-specific decisions regarding security, process and field support. Many fine-grained rules that can differ by client—e.g., client A may allow store managers to deactivate devices; client B may allow this at a store support center only; client C may have (badge) provider do this for them.
(e) Data services: Manage flow of data to & from devices.
   Stages data to be sent to devices—software updates, content etc. Implements rules that determine which updates apply to which individual devices, based on client/brand/store/device type etc. Provides data to communication services layer when per-device updates are requested.
   Receives data sent from devices—sensor data, battery status etc. Accepts data from communication services layer and applies rules to determine how data should be processed, stored and archived.
(f) Integration services: Allows external users & systems access to data/processes/events. This is common access/reporting layer over all the other services that manage data (directory, data, permissions etc.)
   Reporting services allow access to information managed by the directory & data services. For instance, clients and client support teams may need to have access to lists of devices, their location/status and so on.
   Events services provide notification when specific alerts/events/conditions occur. E.g. clients or partner field service teams may need to be alerted about devices that have dying batteries, devices that haven't communicated with the network in XX hours, or other conditions requiring action/repair.
   Integration services include both user-interactive (in a web browser) and system-integration (data access via API or structured data feed. The same data and permissions apply in all access paths.
(g) Device deactivation: Make the device unusable. In response to various manual and automated events. E.g. a user may learn a device is broken, and deactivate it via the web interface; or an automated process may apply saying any device that hasn't communicated with the system for 30+ days should be automatically deactivated.

### Device Provisioning

Device provisioning is the process by which bulk-manufactured hardware is configured and tested to the specification required for a particular client/order. This is analogous to the process for non-digital badges in which bulk physical components (blank plastics, ink etc.) are printed, cut, and assembled to create the badges a client ordered. For the digital product, however, the bulk components are a combination of physical assets (circuit board, screen, battery, enclosure) and software assets (firmware, device software, on-device data) that are combined and verified before shipping.

The business purposes of this process include:
Make a device usable by the intended client (only)
Make it impossible for a 3^{rd} party to add devices to our network without permission
To record information about the device
   For general record-keeping
   For client inventory & billing
   For use by the device management and content management systems
Prepare the device to be activated at client's location

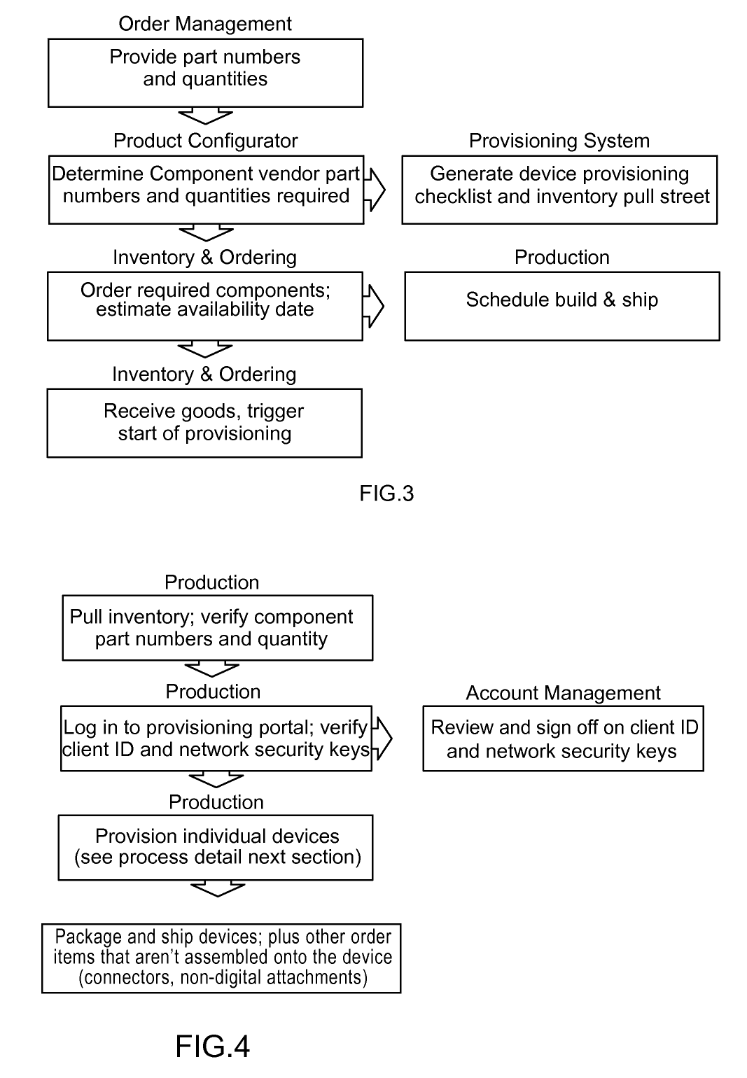

FIG. 3 illustrates a flow diagram of a method for defining bill of materials and provisioning checklist, according to one embodiment. This process may be preceded by a “Receive & Acknowledge Client Order” process. Working with the client, sales people and/or provider may define the number and type of devices needed to fulfill the order, at a SKU and/or component level of detail. For example: client X requires 50,000 model “A” badges (part #123) with options (a) type “5” enclosure in red (part #45), (b) type “2” wireless rechargeable battery (part #78), and (c) type “3” lanyards in grey (part #90). FIG. 4 illustrates a flow diagram of a method for building and shipping an order, according to one embodiment.

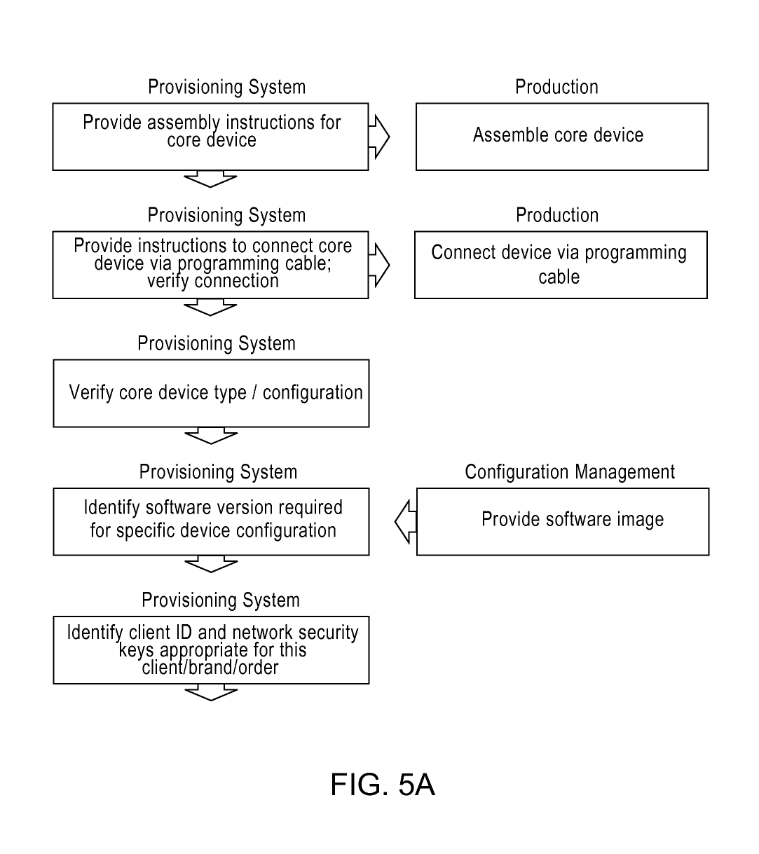

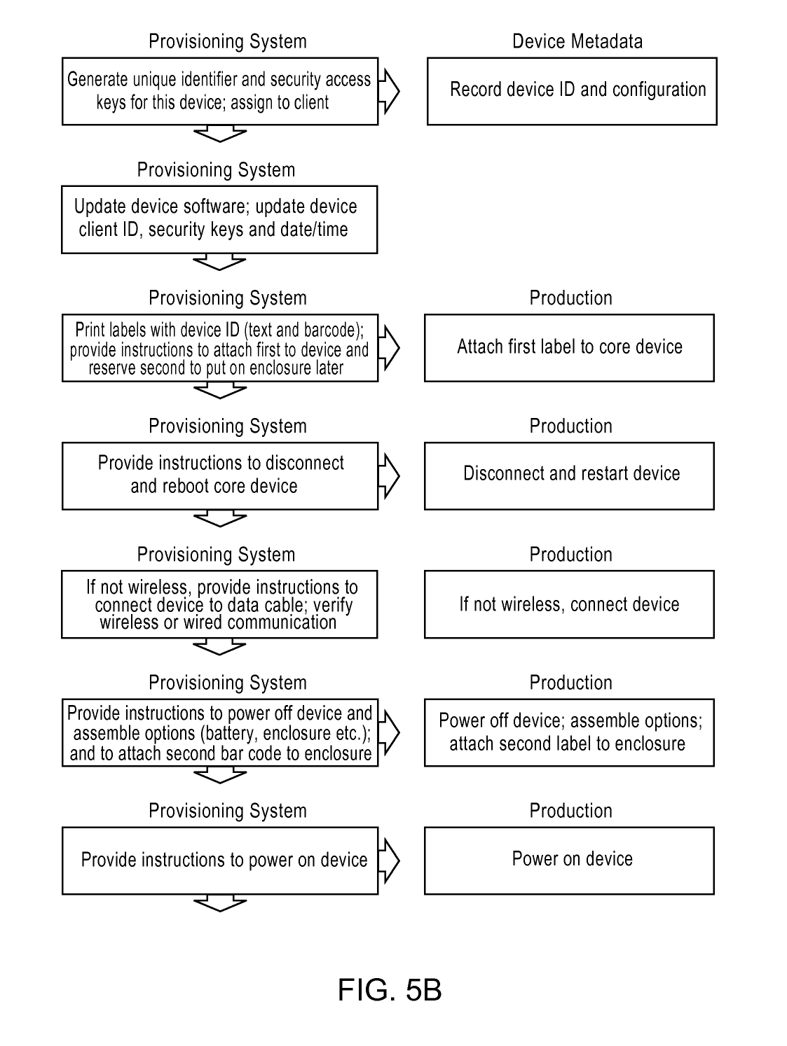

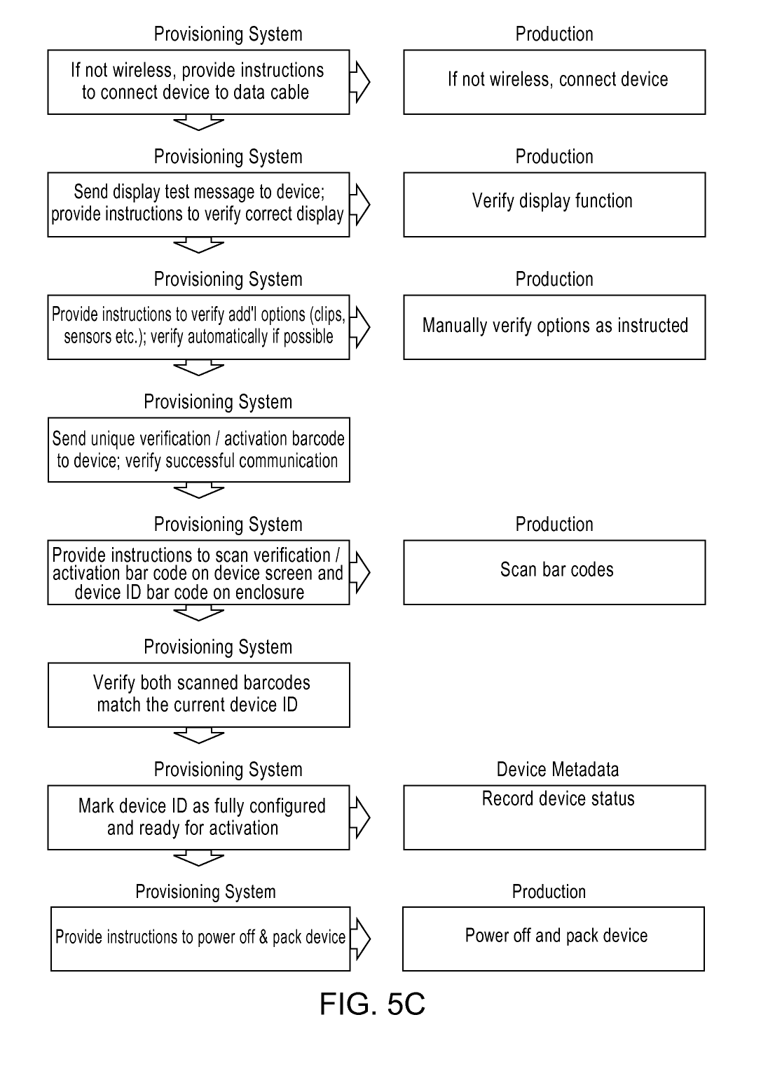

Embodiments provide a Device Provisioning Portal to guide the production and build process. This Device Provisioning Portal may include on-screen instructions, and will configure each device using wired and/or wireless communication. FIGS. 5a, 5b, and 5c illustrate a flow diagram of a process for provisioning individual devices, according to one embodiment.

An alternative process for devices with neither wireless nor wired communication capability changes a few of the steps: for example, instead of communicating with the device, the provisioning system downloads the required information to a memory card and instructs an operator to insert the memory card in the device. The other steps may be essentially the same.

Additionally, the provisioning process for signs, access points and base stations may be more or less the same as that described above for badges.

### De-Provisioning Devices

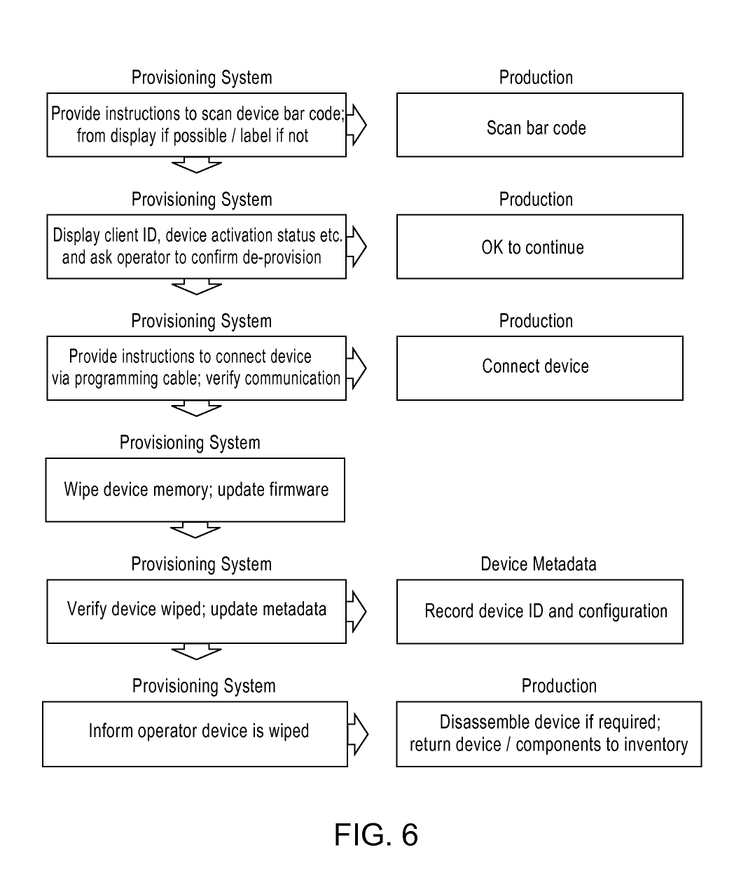

Devices can be de-provisioned to return them to “factory reset” conditions. This may be needed if a device was provisioned by accident or to the wrong client; or to reuse devices that are returned form client for some reason. FIG. 6 illustrates an example flow diagram of a method for de-provisioning a device, according to an embodiment.

Additionally, the de-provisioning process for signs, access points and base stations may be more or less the same as that described above for diplay devices (e.g., badges).

### Device Activation

Device activation is the process by which devices that have been provisioned are put into service at a client location. A device that has been provisioned but not activated will not participate in the content management layer of the system. There may be distinct activation processes for (a) badges & signs; and (b) access points & base stations.

The business purposes of this process include:
Associate the device with a particular client location
Allow the device to receive updates from the device management system

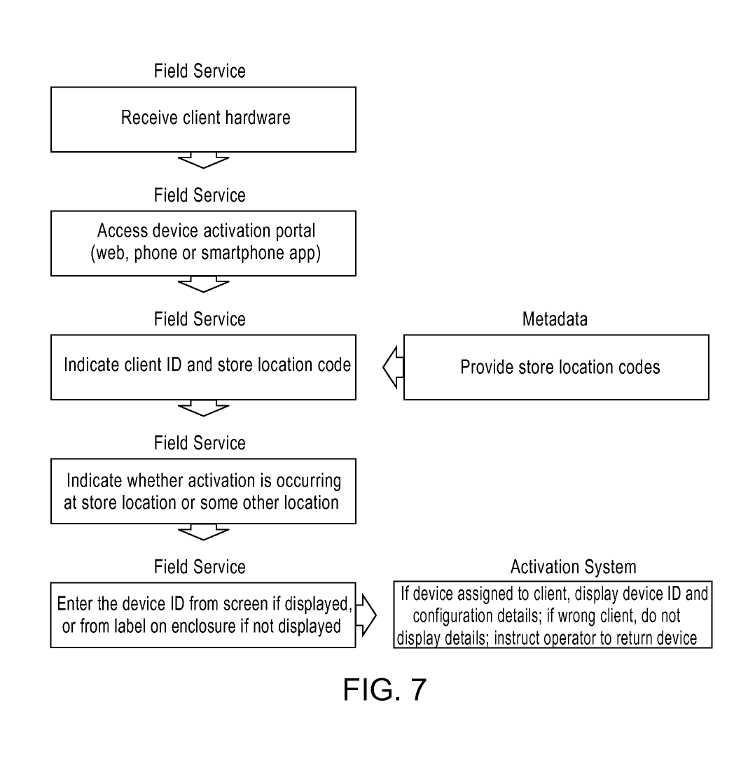

FIG. 7 illustrates a flow diagram for a method of an activation process, according to one embodiment. In certain embodiments, the “Device Provisioning” process defined in the above section precedes this activation process. In an embodiment, devices that are not provisioned (either have never been provisioned, or have been provisioned then later de-provisioned) cannot be activated.

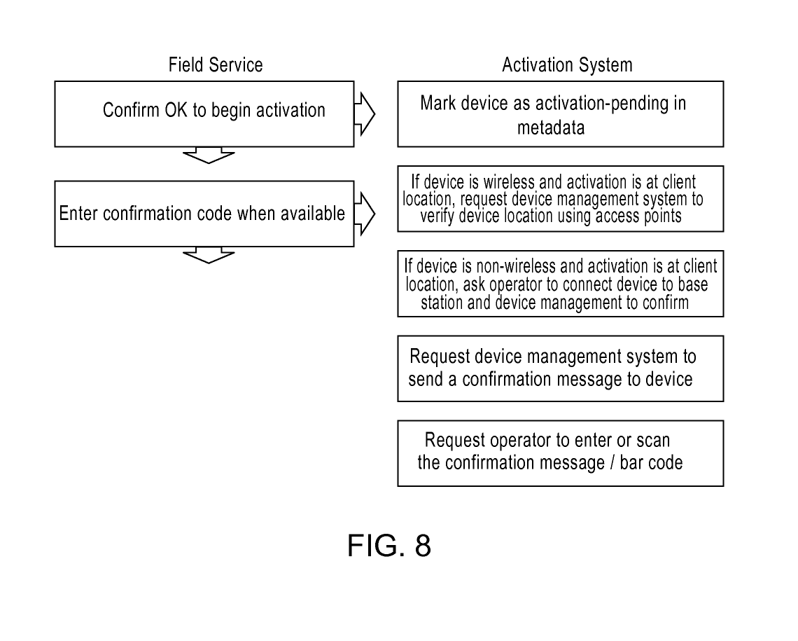

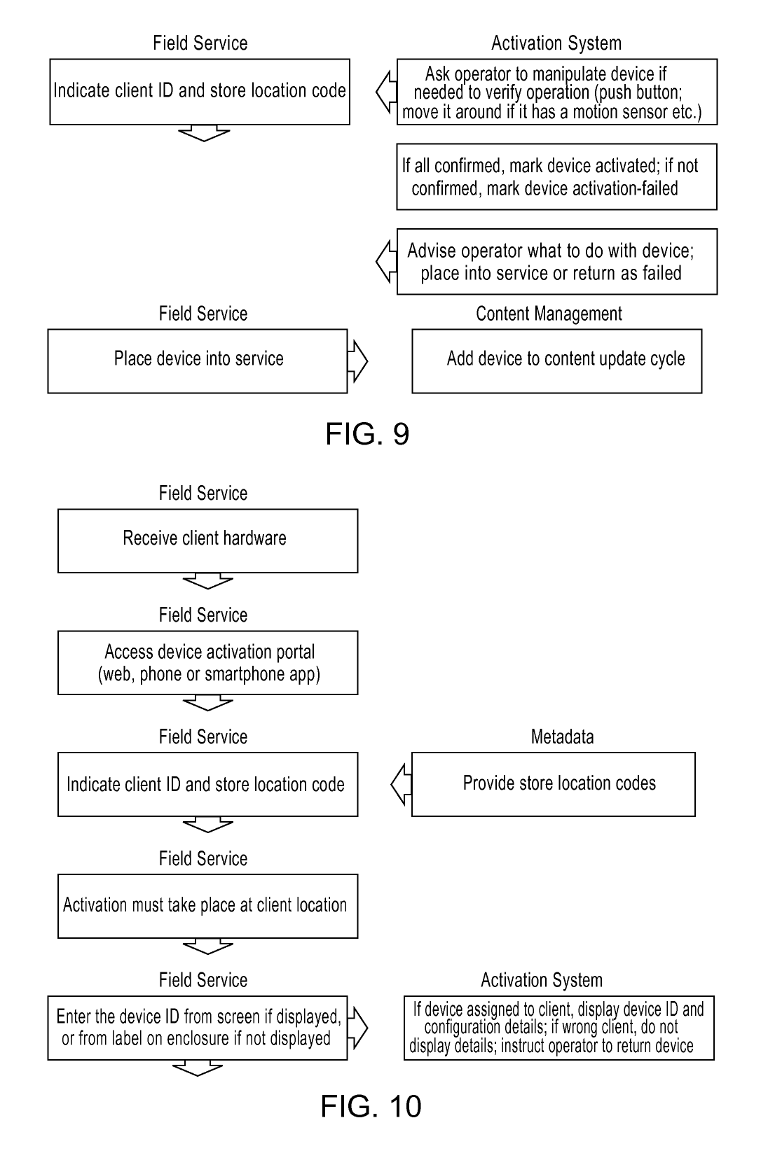

It should be noted that the above steps may differ by how the activation portal is accessed. If via telephone call or web site, an operator may enter the numeric version of the device ID from the screen or label. If via smartphone, an operator would have the option to scan the bar code from the screen or label, or enter the numeric code from the screen or label. FIGS. 8 and 9 continue to illustrate examples of a flow process for the activation method, according to one embodiment.

It is noted that if activation is happening somewhere other than client location (e.g., a warehouse or other location), in one embodiment the device may remain in pending mode until it connects to a base station or wireless access point at the client location.

Embodiments may provide a variation of the above in which the device is activated using a POS terminal (e.g., cash registers) in the store, for example. For clients who elect to associate badges with employees via transactions on a POS terminal, it would make sense to activate devices the same way. Instead of calling a phone number or using a web app or smartphone app, a field agent would use a POS terminal in the store to scan the bar codes or enter the text codes.

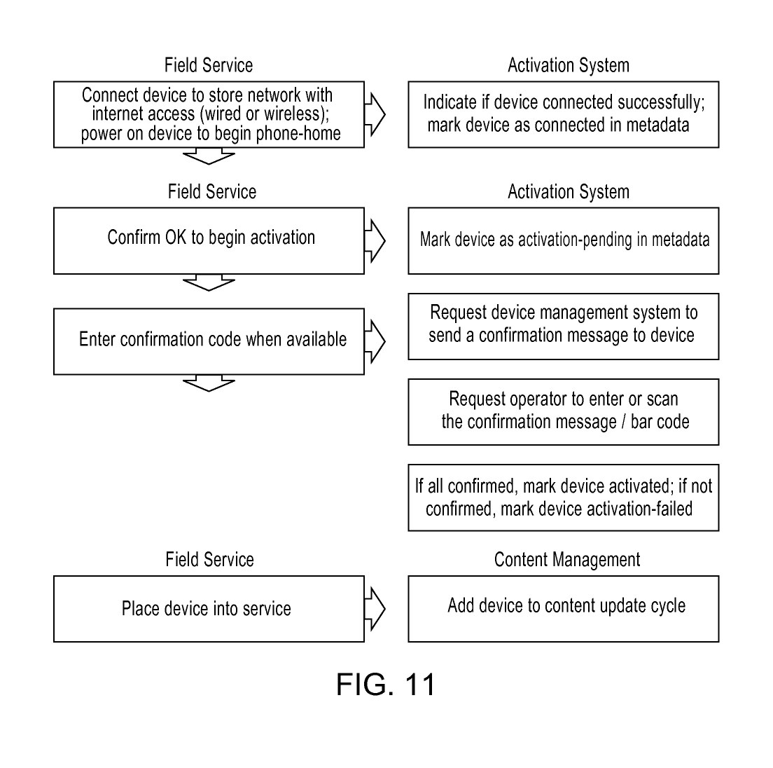

FIGS. 10 and 11 illustrates an example flow diagram of a method for activating an access point or base station, according to one embodiment.

It is noted that the steps of FIGS. 10 and 11 may differ by how the activation portal is accessed. If via telephone call or web site, operator would enter the numeric version of the device ID from the screen or label. If via smartphone, operator would have the option to scan the bar code from the screen or label, or enter the numeric code from the screen or label.

### Device Management

Device management is the process by which each device is managed and maintained through its lifecycle, including but not limited to: monitoring its health status (when last connected; battery level), delivering periodic software updates, deactivating if lost or stolen, etc.

The business purposes of this process include:
Ensure devices are working properly;
Communication & security are maintained between device and our network;
Advise field service when a device needs attention.

The “Device Provisioning” process defined above precedes this process. Devices that are not provisioned (either have never been provisioned, or have been provisioned then later de-provisioned) cannot be managed. It is noted, however, that devices do not need to be activated; certain device management functions take place before activation.

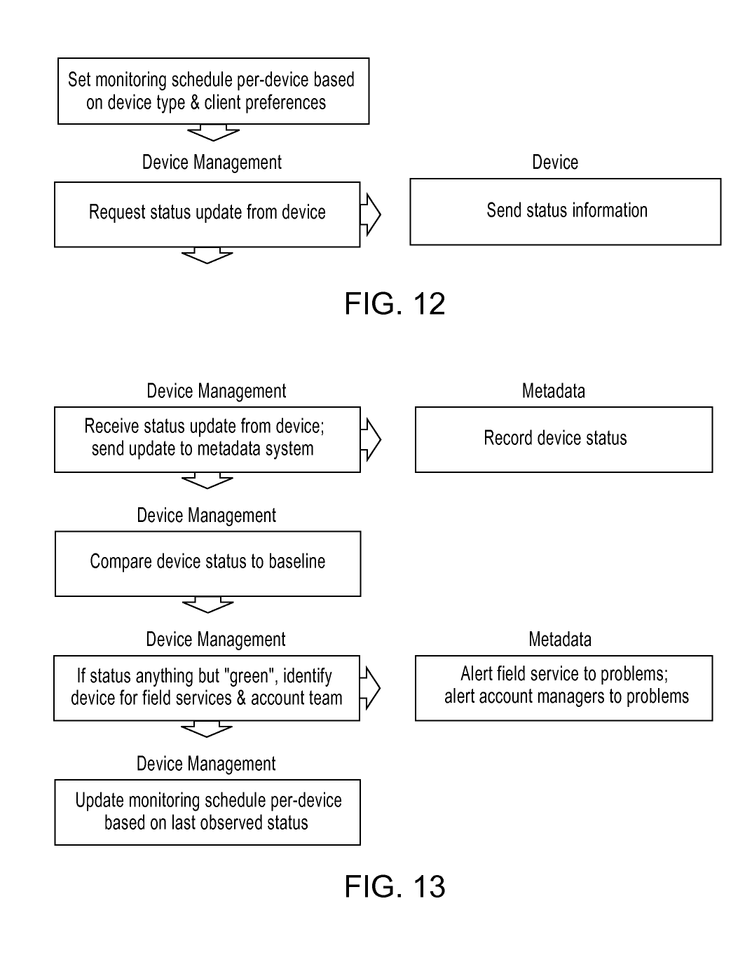

FIGS. 12 and 13 illustrate a flow diagrams of a method for monitoring a device status, according to an embodiment. It is noted that this process may vary with device type and configuration. Devices will report awake/alive; when does device think last communication with the network was; and firmware and software versions running. Badges/signs will report battery status, sensor status etc.

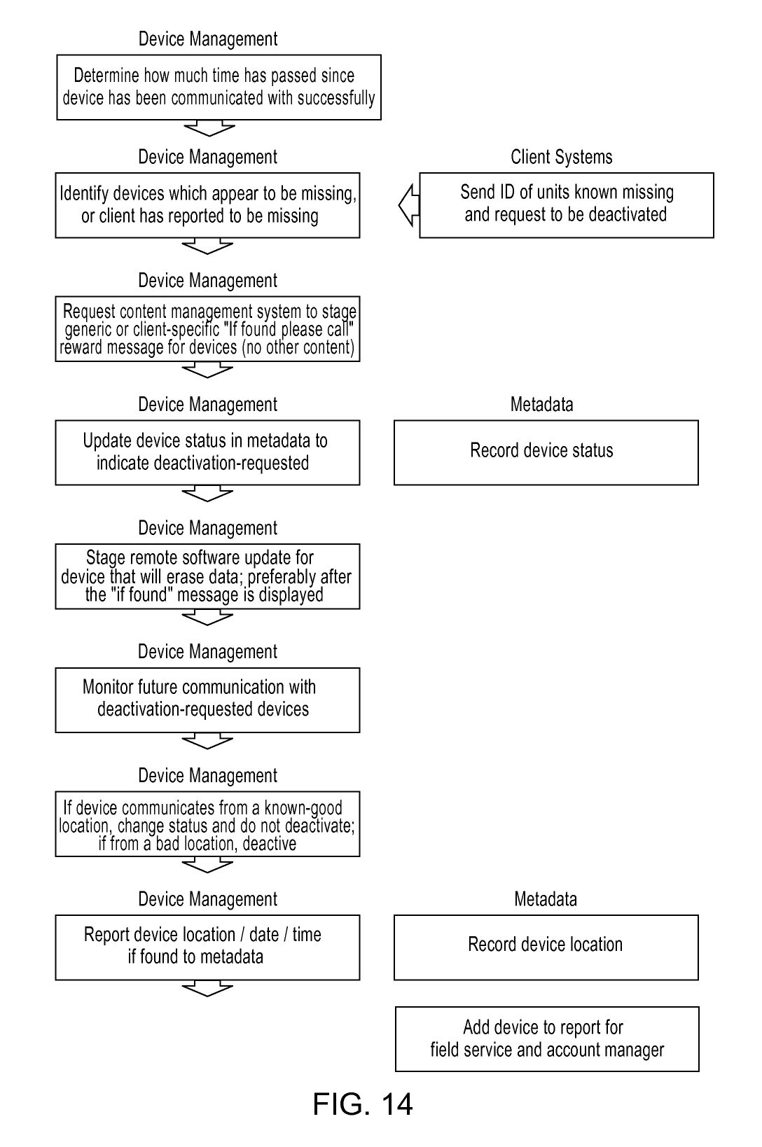

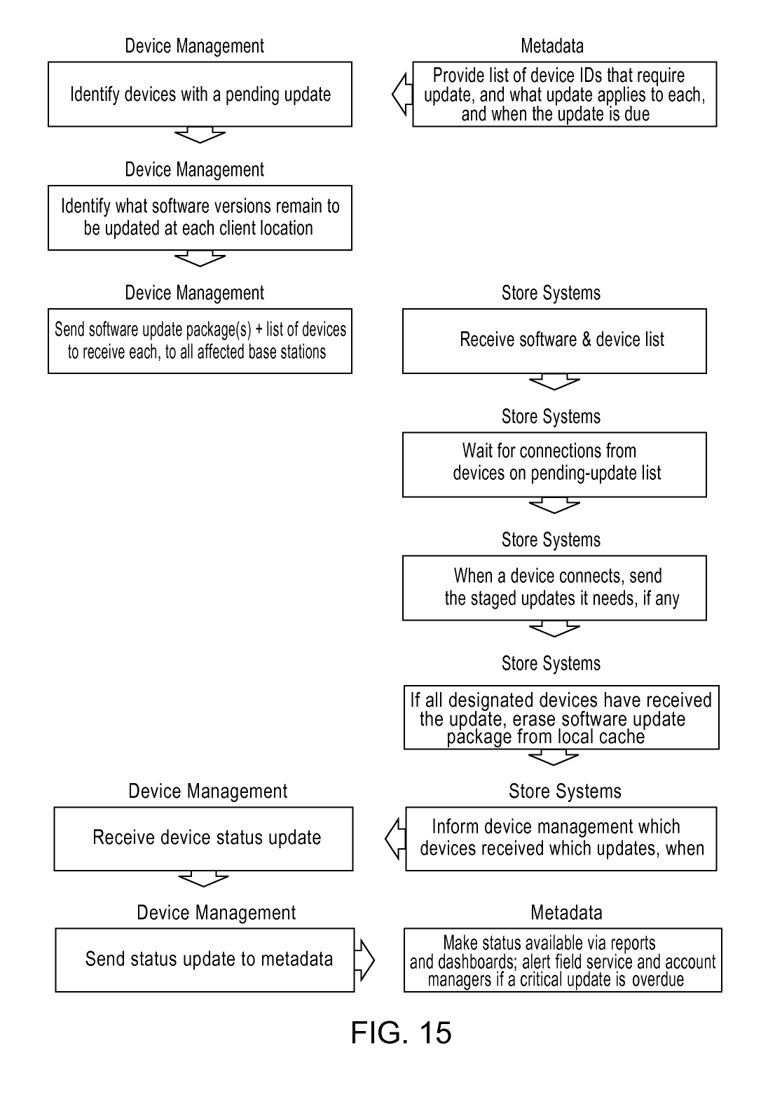

FIG. 14 illustrates a flow diagram of a method for loss prevention and remote deactivation, according to an embodiment. FIG. 15 illustrates a flow diagram of a method for delivering a software update to a device, according to an embodiment.

### Content Management

Content management is the process by which content is generated for and delivered to each device. This includes relatively fixed content like a client logo, content that is changed by the client's own actions (associate name & title; promotional info), and also content changed indirectly by 3rd parties (brand advertising including from an auction process).

The business purposes of this process are:
Ensure each device is displaying the correct content
Allow client to define how content will be formatted & displayed
Allow client to determine which parties are entitled to update which content
Connect clients with a network of brands/advertisers providing ad content

The content management layer is responsible for preparing content to be delivered to individual devices.
(a) Users & permissions services: Defines groups of users, individual users, and their permissions in the system.
(b) Authoring services: Helps users create content that can be used by the system & all of its devices.
   Upload—allows users or automated systems to upload content in one or more formats. For example, a consumer brand may have text-based and graphical ads to be delivered to many devices.
   Format—converts user-provided content to device-specific formats (e.g., black and white for paper-white badges, full color/various sizes for signs, full color/various sizes for badges etc. Provides user with previews of how content will appear on all relevant devices, so user can choose to use system-provided formatting, or use tailored text and images for specific device formats.
(c) Workflow services: Implements a review and approval process for different content types and providers. For example, clients may require no workflow approval for content managed by their own corporate marketing teams, but may choose to review & approve or reject content provided by 3^{rd} parties content providers like advertisers.
(d) Campaign management services: Allows content providers to define a plan and schedule for content, and rules for its publication. E.g. a consumer products advertiser is preparing to launch a new product—their team would define ad content & formats 1-2 months before launch, and define rules for when/where the content can appear (retailers, regions, specific stores, departments in the store, times of day). Or a client's own marketing team may define a holiday promotion months in advance, and rules for regional content. Campaign management is the provider side of the content matching/publication logic—where providers would like content to go.
   Interacts with auction services (see below) to provide users information regarding which brands, regions, device types etc. will be involved in the campaign, based on current directory data.
   Interacts with device management services to estimate the number & type of devices that a campaign would apply to, given auction results (which clients/regions/stores would be involved) and directory info for devices (how many devices are now deployed for those clients/regions/stores).
(e) Auction services: Match content/campaigns with devices. Allows device owners to determine which content streams/campaigns should be used for which devices (brands, regions, stores, departments, etc.) when. Auction management is the device owner side of the content/publication logic—what content clients will allow.
   This can be a bid auction process in cases where 3^{rd} party advertisers are involved.
   This may be a much approval workflow process when clients manage their own content.
(f) Staging services: Publishes content to the device management layer so it can be delivered to devices. Provides formatted content for applicable devices, and rules for which content applies where (client, brand, region, store, department, etc.). The content management service doesn't communicate with the devices or apply the content directly—it hands content to the device management layer, where the device directory is used to decide which devices get which content, and data services are used to send content to the devices along with other updates.
(g) Integration services: Allows external users & systems access to data/processes/events.
   Reporting services allow access to information managed by the content management service. For example, content providers will need to review lists of future and past campaigns, campaign statistics (what content appeared on how many devices by brand/region/etc., for what periods of time).
   Integration services include both user-interactive (in a web browser) and system-integration (data access via API or structured data feed. The same data and permissions apply in all access paths.

The “Device Activation” process defined above precedes content management process. Devices that have not been activated do not receive content updates other than a few special-purpose operations relating to management of lost devices.

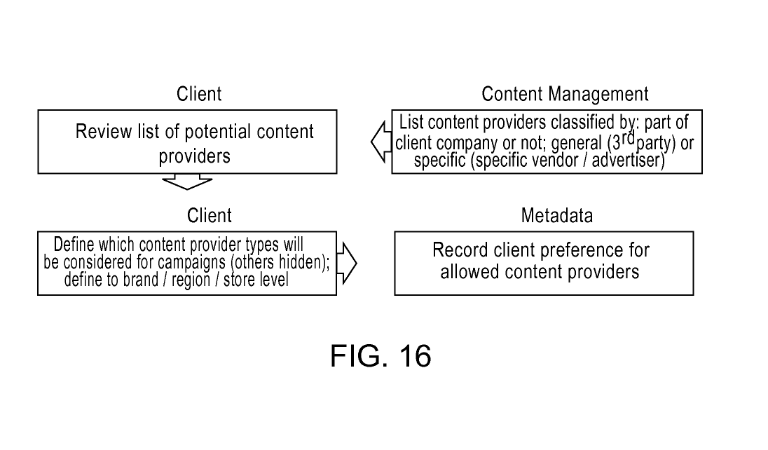

FIG. 16 illustrates a flow diagram of a method for defining content providers, according to an embodiment. This process allows clients to define the universe of potential content providers. This does not select actual content, that process may occur later. This step would allow a client to say, for example, all content must come from our own company except we will entertain the idea of campaigns from a certain company or organization. This may be the first level of filter for an auction process.

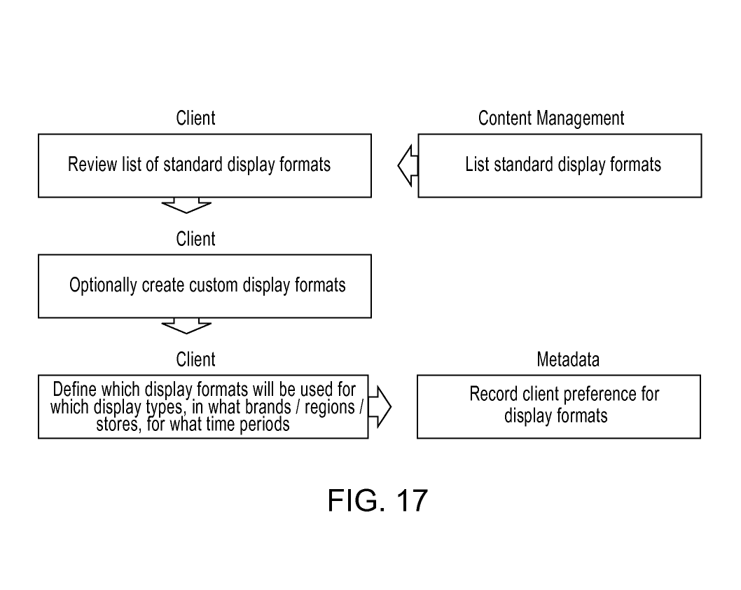

FIG. 17 illustrates a flow diagram of a method for defining display formats, according to an embodiment. This process allows clients to define how the screen real estate will be used for different device types; e.g., a small device may have room only for a name and title, while a larger device has room for an employee photo and advertising message as well. This is important because content providers need to design/author content to fit into these display formats.

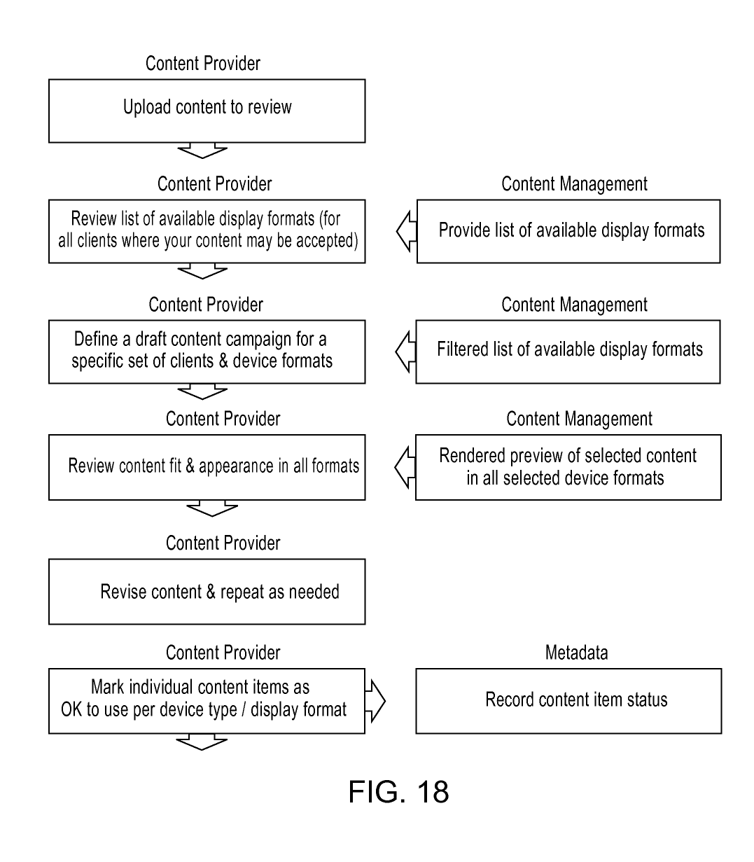

FIG. 18 illustrates a flow diagram of a method for authoring content, according to an embodiment. This process allows content providers to upload content, and preview how it will appear on different device formats.

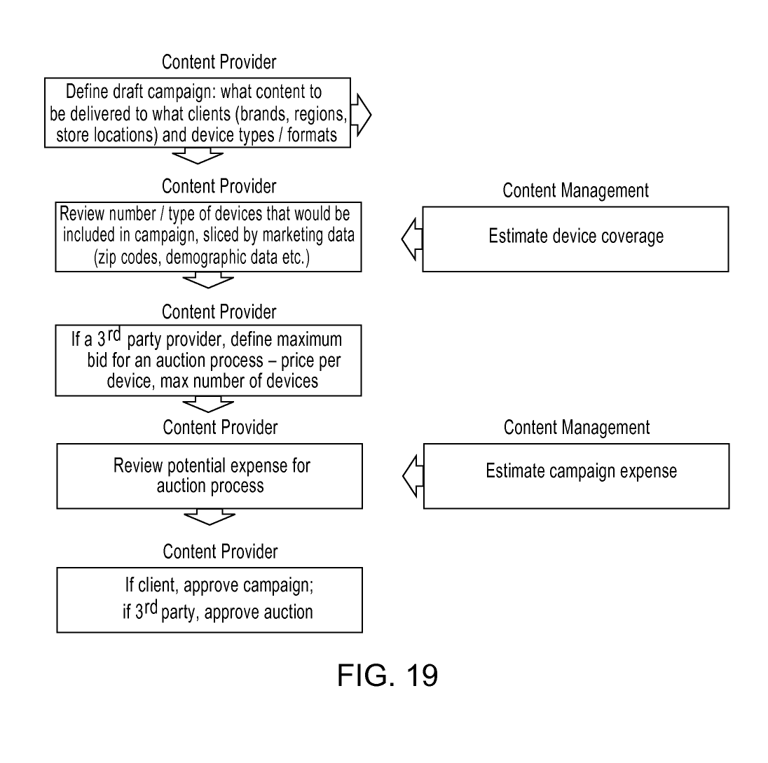

FIG. 19 illustrates a flow diagram of a method for defining content campaigns, according to an embodiment. This process allows content providers to define what content should be used where (clients, brands, regions, stores) and when. If the content provider is company-internal, content can simply be scheduled once ready. If the content provider is a 3^{rd} party, a content review by the client, and/or an auction process, may be required before a campaign is accepted.

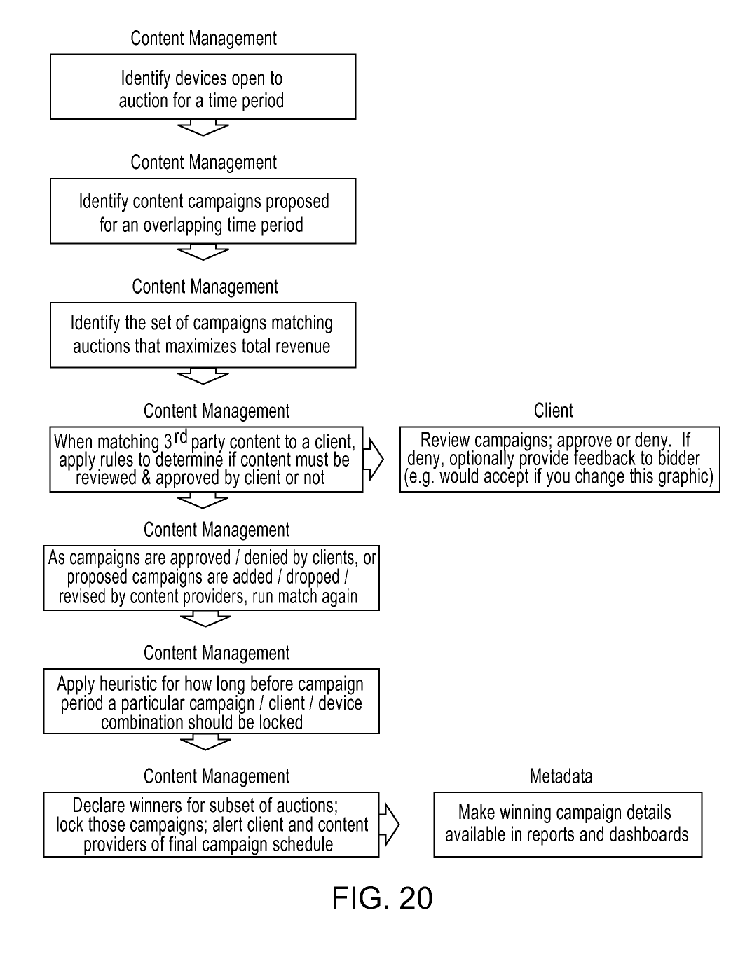

FIG. 20 illustrates a flow diagram of a method for operating an auction for content, according to an embodiment. This process may match content to devices for a future date.

It is noted that when the content provider is always the assumed winner of a client's display real estate, e.g., client approved only company internal providers, and only one campaign is defined—the auction process is short-circuited. There is still a possibility of clients having more than one content provider in their company, in which case the auction does run as it would for 3^{rd} party content.

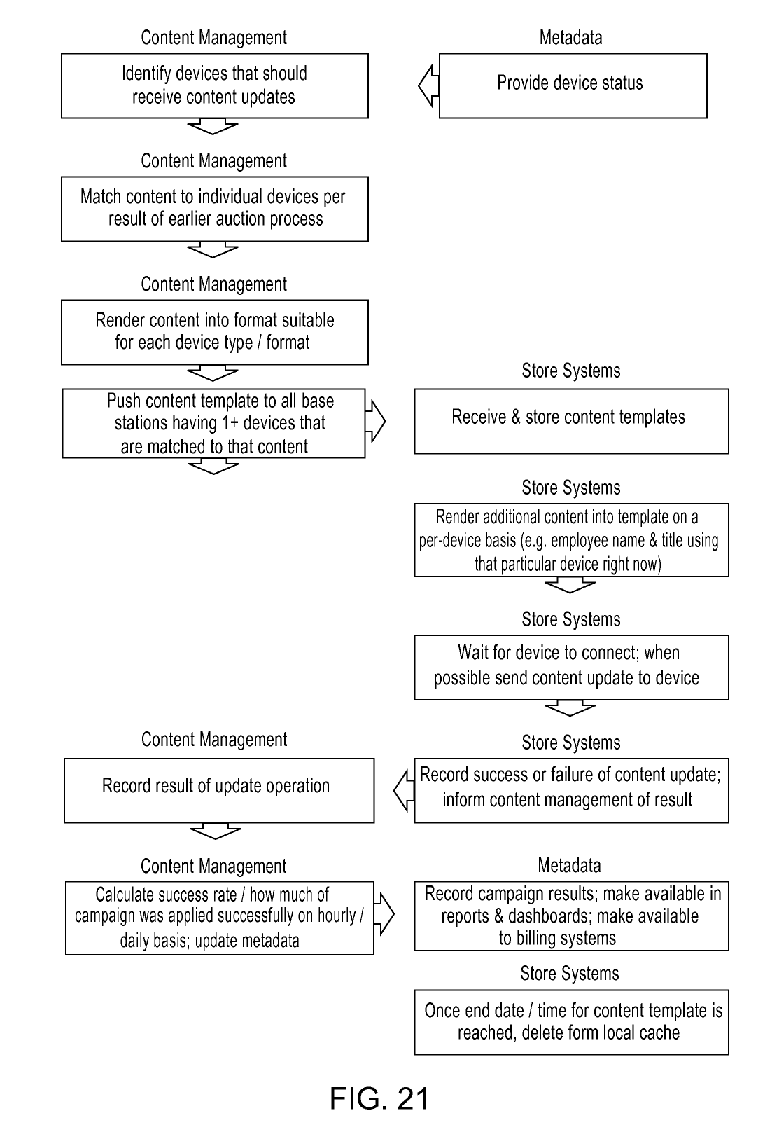

FIG. 21 illustrates a flow diagram of a method for updating a device display, according to an embodiment. This process matches pushes the correct content to each device at the specified date & time.

### Device Association

Device association is the process by which an individual badge it assigned to a person who will wear it, or an individual sign is assigned to department/location where it will reside, so appropriate content can be sent to that device. The business purposes of this process include:
Ensure the content management system can match content templates to this device;
Store systems can put the right local information (name, title etc.) onto the device;
Marketing information about devices (like which department it is in) are recorded in the metadata system to be used by content management when providing estimates regarding campaign matching to devices.

The “Device Activation” process discussed above precedes the device association process. Devices that have not been activated cannot be associated. Store location and other activation information may be required before association can occur. There may be slightly different processes for associating badges with employees vs. signs with departments/locations.

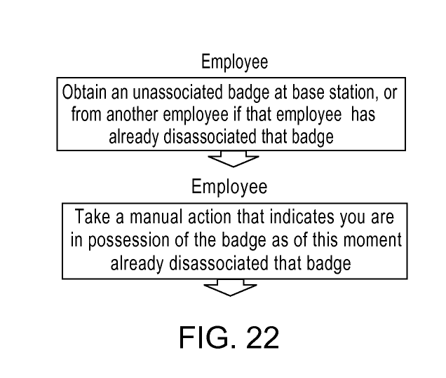

The process for associating badges to employees allows clients to associate a certain badge with a client, as shown in the flow diagram of FIG. 22.

There are several ways this badge association may be done. An unassociated badge may display a number code and a bar code (various symboligies possible). Given the badge and that code, the employee could cause the association process to begin in a number of ways:
POS terminal: Employee could log in to a POS terminal as usual, then use a function key to initiate the process; then enter the number using the POS keypad, or scan the badge using the POS price scanner/bar code reader. The POS system would communicate with the wireless access point (either directly using the store network, or indirectly by sending a message to our servers, which would in turn contact the wireless access point).
Other specialized terminal: For clients who have other computer terminals available for employee use—perhaps part of a timekeeping system or some other administrative function—the employee would log in then use a web app we provide enter the badge number code using the keyboard. The web app would communicate by sending a message to our servers, which would in turn contact the wireless access point.
By telephone: Perhaps for employees in locations that don't have the right technology infrastructure, or as a backup system if other systems become temporarily unavailable, the employee could call a specific phone number, enter their employee ID and badge number. The phone-based application would communicate by sending a message to our servers, which would in turn contact the wireless access point.
By smart phone: This approach is similar to the POS scenario—employee uses smart phone camera to scan the badge. The employee could be identified automatically if using a smart phone that is known to be used by that individual (company issued?) or could have a log-in process as in the other approaches above. Note that if we need to provide an expensive specialized terminal clients can put in employee break rooms to manage badges, we would probably use a smart phone/tablet due to its small footprint and low cost.
By time-keeping system. For clients that have an electronic time-keeping system, the user could clock in using their employee ID number or other normal mechanism, then use the device barcode to associate the device from the same time-keeping terminal. (As a practical matter, we need to learn more about capabilities of the time-keeping terminals; but from a patent perspective I think this seems reasonably likely).

In all cases, the employee knows the badge has been associated when his name/title/etc. appear on the display.

The process for disassociating badges from employees reverses the association that was accomplished in the previous process. The employee, using one of the mechanisms described for association, can carry out the disassociation. Disassociation can also be done by someone other than the employee: e.g., if an employee leaves for the day without disassociating the badge, a manager or fellow employee can disassociate the badge without having the other individual's employee ID or login information.

Additional ways to disassociate may include:
By base station. If the client uses a base station that physically connects to devices for recharging (via cables or contact points), the base station will identify the badge and disassociate it. If the base station or magnetically couples with the device for recharging (via induction coil), the device will transmit a status update saying that it's connected to the base station, and that will trigger a disassociation from the device management layer.

### Digital Display Badge

One embodiment is directed to a digital (text and/or graphical) display as a name/identity badge, for example.

Updateable Digital Display Badge

In certain embodiments, some portion of the display can be updated from time to time. The display may incorporate digital/rewritable display elements.

Updates may be effected by:
Plugging display into a wired connection;
Device being in range of short-range wireless connection;
Device being in range of long-range wireless connection;
Replacing a memory card installed in the device; or
Other approaches

Update Display in Response to Events

In certain embodiments, portions of the display may be updated based on rules or events. For example:

Rule 1: fetch or display content X when a certain date & time arrives

Rule 2: fetch or display content X when inventory for a given product moves above or below a critical level.

Rule 3: fetch or display content X when a security event occurs, e.g., there is a tornado warning

It should be noted that many such rules can be defined and embodiments are not limited to the above examples.

Digital Display Badge+Mounting Hardware

In an embodiment, a digital name/identity badge may be combined with mounting hardware. For example, the badge may be removably attached to a person's clothing, accessories and/or body. Various means of attachment may be provided according to certain embodiments, such as: one or more pins (peel & stick, glued with any pin retainer, non-glued molded pin insert, military clutch pin, jewelers pin etc.); adhesive; magnet on device/metal on person or clothing; magnet on person or clothing/metal on device; Velcro-style fasteners; lanyards; strap clips with hole; bulldog clips; alligator clips; necklaces; hats; belt loops; belts; pocket clips; clothes-pin clips; tie clips; ties; sashes; bolo ties; hook clips; O rings; chains; arm bands; zip ties; sewn-in pouch enclosures; backpacks; pin or magnet adapter with alligator, bulldog or clothes pin clip; etc.

Special-Purpose vs. General-Purpose Display

The above may be implemented in terms of special-purpose displays, or for general-purpose displays (smartphones, tablets etc.). Embodiments can deliver the product as hardware+software, or as just software running on a general purpose device.

### Display Configurations

Digital Display Badge+Non-Digital Display Elements

Certain embodiments are directed to a digital display attached to, or configured in relation to, non-digital display elements. For example, digital display+non digital display such that neither display overlays the other (top/bottom, inner/outer etc.)

Digital display overlaid on non-digital display: For example, a fully or partially transparent digital display can be positioned over plastic/paper/etc. display elements that provide (a) color including white backdrop; (b) static text and/or graphics.

Digital display underlaid on non-digital display: For example, digital display can be positioned under fully or partially transparent plastic/paper/etc. display elements that provide (a) color; (b) static text and/or graphics.

In certain embodiments, the paper and plastic elements may be replaceable/updateable.

Multiple Layers of Digital+Non-Digital Content

If digital or non-digital displays are fully or partially transparent, they can be layered. This allows different combinations of text & graphics to be configured and different layers to be replaced at different times.

Definition of Display Regions for Content Syndication

One embodiment may define regions within the display that can be separately addressed for content updates, and update them separately. For example: a display could be defined to have a Name and Title region, and Brand region and an Advertiser region. The name & title could be updated by the system when store employees clock in or out. The brand region could be updated by the client's marketing department to use logos or messages from the brand. The advertiser region could be updated by a 3^{rd} party selected as an approved advertiser to use logos or messages from the advertiser.

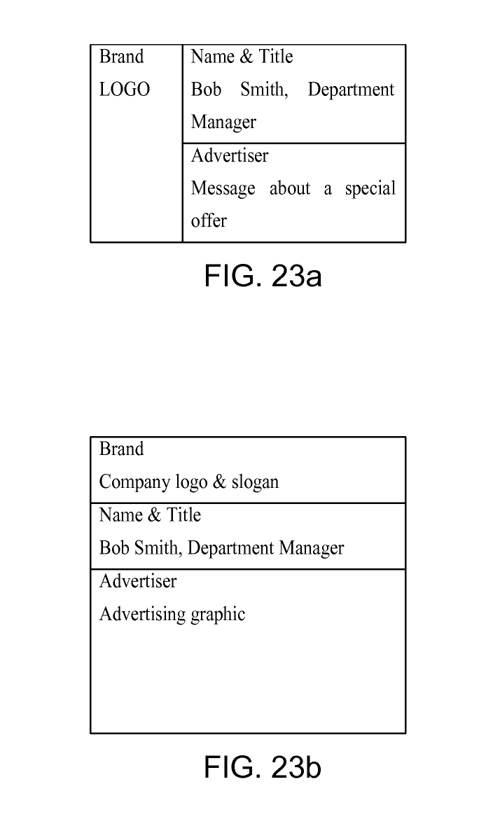

In certain embodiments, Different display schemes could be defined based on (a) device capabilities and (b) client preferences. FIG. 23a illustrates an example display for a small badge. In the example of FIG. 23a, a digital or electronic display of the badge may show the company's brand name and/or logo, the name and/or title of the employee wearing the badge, and may also have a section for advertising and/or special offers. FIG. 23b illustrates another example display for a larger badge. In the example of FIG. 23b, a digital or electronic display of the badge may show the company's brand name, logo, and/or slogan, the name and/or title of the employee wearing the badge, and may also have a larger section for advertising, graphics, and/or special offers.

### Device Management

Assign Badge to a Specific Store Location

In one embodiment, a badge may be configured and shipped with pre-defined display content that identifies the badge and can be read/scanned by store systems. Cause the badge to be read/scanned by the store system. Use the data resulting from this to relate badge to store.

For example, a badge is shipped with display content depicting a bar code, QR code or other indicia readable by store POS terminals. Scan badge at a POS terminal in the desired store. Store systems forward data to device management system.

In another example, a badge is shipped with display content depicting a standard UPC-style barcode that identifies the device type, plus a long gift-card style barcode that identifies the specific device. Scan both barcodes in the same way a gift card is activated. Gift card activation system forwards data to the device management system.

In yet another example, a badge is shipped with display content depicting an alphanumeric ID for the device. Store personnel use an automated phone system and/or web service to enter the device number and request activation.

Assign Badge to a Specific Employee

In another embodiment, the badge may be permanently or temporarily assigned to an employee during the work shift.

Loss Prevention

In certain embodiments, a loss-prevention device may be attached or embodied in the badge. The particular type of loss-prevention device used can match what the client has installed at the site location the badge is being configured for.

### Content Management

Auction Process for Content Syndication

An embodiment may define multiple allowable sources for badge content, and rules that determine which content goes to which device. In an embodiment, auction participants are authorized to participate in particular auctions. An auction can be defined in terms of one or more clients/brands, one or more regions/states/cities, sets of or individual stores based on their location or metrics of interest to advertisers (consumer demographics, store traffic, other) as well as particular periods of time (range of dates, hours of the day). Participants bid for some number of clients/brands, stores, devices, etc. Content for the winning bidder is published to the matching devices for the specified time period. The auction may be administered using software designed for this specific application.

The auction could also be administered by using existing auction solutions. In particular, a web-based approach may be defined that uses the client, brand, region, store etc. as part of the web address, and a 1:1 relationship between each individual device and a web page. This would allow existing tools such as Google Ad Sense™, with its existing auction mechanism and network of advertisers, to be used to implement the auction and content syndication for ads.

Review Process for Content Syndication

Some embodiments may verify content is acceptable before publication (before or after auction). For example, to protect their brand and reputation, clients may choose to review & approve content from 3^{rd} parties. In one embodiment, the content is part of the auction bid process. The client may review and approves content as part of authorizing the bid. Once a content provider wins an auction, changes to content must be approved. In another embodiment, the content is not reviewed & approved until after the auction has been won.

Use of Metadata to Implement Content Syndication Auctions

Content owners may wish to target their content to specific brands, locations and device types. When matching bids to offers in the auction process, metadata can be used to define which offers are of interest to content providers. Retailer brand, vertical (e.g. grocery, sporting goods, fast-food restaurant etc.), region(s), single store locations, store statistics (size, consumer demographics, zip code etc.), and display types (black & white, color), size etc. can be used to filter offers in/out, or to score them for relative fit to the content provider's selection criteria.

Likewise, metadata can be used to define which bids are of interest to badge owners. Content provider brand, vertical, campaign type, campaign length can be used to filter bids in/out, or to score them for fit to the owner's criteria.

Business Rules to Determine Content at Device Level

In certain embodiments, the client will be able to define business rules that determine the correct content for each device at a specific time. Business rules can be based on any data or metadata concerning the client/brand, region, store, employee, device etc. and any metadata concerning the provider brand, content, time of day, day of month, day of year and other factors. Business may be applied in priority order to determine what display scheme and content is correct for each device.

Formatting and Pre-Staging Device Content

Net of all business rules; prepare content to be delivered efficiently to each device. Recognize that many devices will be insufficiently powerful to render their own content (e.g., are not web browsers). The content management system will use device configuration metadata to determine the format required by the device, create the formatted content, and deliver the content to the device management layer to be communicated to the device when possible.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A display device, comprising:
a microprocessor;
a memory; and
a display;
wherein the microprocessor and the memory are configured to control the display device to
receive content from a network device,
receive at least one rule used by the microprocessor to determine when the content is displayed, and
display the received content on the display according to the at least one rule.

2. The display device according to claim 1, wherein the display device comprises an identification badge.

3. The display device according to claim 1, wherein the display device further comprises mounting hardware configured to mount the display device on clothing of a person.

4. The display device according to claim 1, wherein the display device further comprises a power source.

5. The display device according to claim 1, wherein the display device further comprises a loss prevention device configured to deactivate the display device when the display device is removed from a predefined premises.

6. The display device according to claim 1, wherein the display device further comprises at least one sensor configured to create data and/or observations and to transmit the data and/or observations to the network device in near real-time; or to store the data to transmit to the network device at a pre-determined time.

7. The display device according to claim 1, wherein the display device has a unique device identifier.

8. The display device according to claim 1, wherein the display device is configured to be associated with an individual, and to display at least a name of the individual.

9. The display device according to claim 1, wherein rules and/or events are defined for when and where the received content is displayed on the display of the display device.

10. A method, comprising:
receiving, at a microprocessor of a display device, content from a network device;
receiving at least one rule used by the microprocessor to determine when and how the content is displayed on the display device; and
displaying the received content on a display of the display device according to the at least one rule.

11. The method according to claim 10, wherein the displaying comprises displaying the received content on an identification badge.

12. The method according to claim 10, wherein the display device further comprises mounting hardware configured to mount the display device on clothing of a person.

13. The method according to claim 10, further comprising providing, by a power source, power to the display device.

14. The method according to claim 10, further comprising deactivating, by a loss prevention device, the display device when the display device is removed from a predefined premises.

15. The method according to claim 10, further comprising:
creating, by at least one sensor of the display device, data and/or observations; and
transmitting the data and/or observations to the network device in near real-time or storing the data to transmit to the network device at a pre-determined time.

16. The method according to claim 10, wherein the display device has a unique device identifier.

17. The method according to claim 10, further comprising associating the display device with an individual, and displaying at least a name of the individual on the display device.

18. The method according to claim 10, further comprising defining rules and/or events for when and where the received content is displayed on the display of the display device.

19. A computer program, embodied on a non-transitory computer readable medium, the computer program configured to control a processor to perform a process, comprising:
receiving, at a microprocessor of a display device, content from a network device;
receiving at least one rule used by the microprocessor to determine when and how the content is displayed on the display device; and
displaying the received content on a display of the display device according to the at least one rule.
